(19) United States
(12) Patent Application Publication
(10) Pub. No.: US 2025/0155986 A1
(43) Pub. Date: May 15, 2025

(54) METHOD FOR DETECTING AND DISCRIMINATING GESTURES

(71) Applicant: VITESCO TECHNOLOGIES GMBH, Regensburg (DE)

(72) Inventors: Ihssen MASRI, Toulouse (FR); Franck D'ARAUJO, Toulouse (FR)

(21) Appl. No.: 18/835,642

(22) PCT Filed: Mar. 1, 2023
(86) PCT No.: PCT/EP2023/055088

§ 371 Date: Aug. 2, 2024

(30) Foreign Application Priority Data
Mar. 4, 2022 (FR) FR2201890

(51) Int. Cl. G06F 3/01; E05F 15/73; G01S 7/35; G01S 13/50; G01S 13/88

(52) U.S. Cl. CPC G06F 3/017; E05F 15/73; G01S 7/356; G01S 13/50; G01S 13/88; E05Y 2400/664; E05Y 2900/546

(57) ABSTRACT

A method for discriminating gestures of a user, implemented within a motor vehicle for controlling the unlocking of an opening when a predetermined voluntary gesture is detected, comprising:
obtaining a basic signal, representing an evolution of a determined Doppler shift following the transmission of an incident radiofrequency signal and the reception of a reception echo;
splitting the basic signal into a first component (Cp1) at the output of a low-pass filter, and, in addition, a second component (Cp2);
applying a first algorithm (Algo1) to the first component (Cp1) in order to obtain a first discrimination result;
applying a second algorithm (Algo2) to the second component (Cp1) in order to obtain a second discrimination result;
   the second algorithm comprising a recurrent computation of standard deviation (σ(k)) carried out based on a sequence of values of the second component and the second discrimination result indicating a voluntary gesture when the computation of standard deviation is below a predetermined threshold.

### TECHNICAL FIELD AND CONTEXT

The present invention relates to methods for detecting and discriminating gestures, as well as to systems implementing them. It notably relates to gestures made by a vehicle user in order to trigger an operation for opening an opening, for example, the trunk or the tailgate or even a sliding door.

### PRIOR ART

The use of a radar sensor for detecting movements is known, with a discrimination algorithm for identifying a gesture voluntarily performed by the user, for example, from document WO 2020/237348.

An application that is now fairly widespread relates to controlling the opening of the trunk/tailgate by means of a foot movement performed by the user under the rear bumper of the vehicle. Another application involves unlocking and/or opening a sliding door based on a gesture performed by a user located in the vicinity of the lateral intermediate pillar (‘B-pillar’).

In the known solutions, it is quite difficult to avoid some false positives, for example, when the user walks behind the bumper, without wishing to trigger the opening of the trunk/tailgate, or, conversely, to avoid non-detections of a gesture voluntarily performed by the user.

The inventors have attempted to improve discrimination performance.

### DISCLOSURE OF THE INVENTION

To this end, according to the present disclosure, a method is proposed herein for detecting and discriminating gestures, intended to be implemented within a motor vehicle for controlling an opening and/or for unlocking an opening when a predetermined voluntary gesture is detected, with said gesture being performed by a user, notably by a hand, a foot, an arm or a leg of the user, the method being implemented by at least one signal processing module, and comprising the following steps:
d/ obtaining a basic signal, Sdp(t), representing, as a function of time, an evolution of a determined Doppler shift following the transmission of an incident radiofrequency signal and the reception of a return radiofrequency signal forming an echo;
e/ splitting the basic signal into a first component obtained at the output of a low-pass filter, and a second component obtained by subtracting the first component from the basic signal;
f/ applying a first discrimination algorithm to the first component in order to obtain a first discrimination result, relating to the detection of a predetermined gesture;
g/ applying a second discrimination algorithm to the second component in order to obtain a second discrimination result relating to the discrimination between a voluntary or involuntary gesture;
   the second discrimination algorithm comprising a recurrent computation of standard deviation carried out based on a temporal sequence of values of the second component and over a sliding time window;
   the second discrimination result indicating a voluntary gesture when the recurrent computation of standard deviation assumes values below a predetermined threshold.

By virtue of the aforementioned provisions, such processing of the second component improves the discrimination of the voluntary or involuntary aspect of a detected gesture. In practice, the first discrimination algorithm provides a first result relating to the correspondence of the generated Doppler signal with a signature of an expected voluntary gesture, and the discrimination is further improved by means of the second discrimination algorithm, which works on a second order component of the basic signal. Indeed, a voluntary signal has a reduced standard deviation compared to that corresponding to footsteps along the bumper or treading at this location.

It should be noted that when the user performs an involuntary gesture, the user is not necessarily located exactly opposite the sensor and the superposition of several gestures will generally be detected, for example, the superposition of a movement signal relating to the right leg and a movement signal relating to the left leg. The criterion proposed over the result of the computation of the standard deviation can be extrapolated to many similar or analogous situations.

The decision is made practically in real time, the implementation of the second algorithm does not significantly increase the computation and decision-making time.

This avoids having to use neural networks or complex algorithms.

The features disclosed in the following paragraphs optionally can be implemented independently of one another or in combination with one another.

According to one aspect, the following preliminary steps can be provided:
a/ transmitting an incident radiofrequency signal toward a detection zone (ZD);
b/ receiving a return radiofrequency signal in return, originating from the reflection of the incident radiofrequency signal on elements located in the detection zone;
c/ determining a frequency shift, called Doppler shift, between the incident radiofrequency signal and the return radiofrequency signal, the Doppler shift being a function of a movement of said elements located in the detection zone, and constructing the basic signal Sdp(t).

Said return radiofrequency signal corresponds to the aforementioned signal forming an echo, used in step d/ of the method according to the invention.

According to one aspect, the basic signal Sdp(t) can be in digital form, i.e., in the form of a temporal sequence of values (S(n)), preferably with a number of samples per second (Pn) ranging between 500 and 2,000.

This confers flexibility and versatility upon the advocated solution, and the solution can be suitable for multiple applications; a relevant compromise is formed between the precision of the process and the required memory size.

According to one aspect, steps d/ to g/ are preferably carried out based on a digital signal, and optionally step c/ also could be carried out in digital mode. Thus, the hardware part is solely limited to the high-frequency signals and everything else is processed by versatile digital solutions that are easy to adapt to several target applications.

According to one aspect, the temporal sequence of values (S(n)) can be obtained at the output of a fast Fourier transform (FFT) module. Specialized modules or components incorporating such an FFT are available and inexpensive. The solution is thus optimized.

According to one aspect, the recurrent computation of standard deviation (σ(k)) carried out based on a temporal sequence of values (U2(n)) can be carried out a number Pk of times per second, with Pk ranging between 10 and 100. It is possible, for example, to carry out the recurrent computation of standard deviation 50 times per second. The necessary computing power remains reasonable due to the sub-sampling of Pk/Pn.

According to one aspect, the extent (or width) of the sliding window for the recurrent computation of standard deviation (σ(k)) ranges between 0.1 second and 0.2 seconds.

According to one aspect, provision can be made to compute standard deviation over a set of 50 to 250 values of S(n), notably the most recently acquired values.

According to one aspect, the extent of the sliding window can be a calibration parameter defined in relation to the target application for detecting gestures.

According to one aspect, the extent of the sliding window can be an adaptive value obtained by a self-learning process.

According to one aspect, the first component advantageously can be time-shifted by a delay value introduced by the low-pass filter, before being subtracted from the basic signal in order to obtain the second component (Cp2).

The delay effect of the low-pass filter is thus compensated, and subtraction is carried out on coherent values. In practice, the delay of the low-pass filter corresponds to 3 to 10 samples of the signal S(n). Therefore, the delay to be compensated is of the order of a few milliseconds.

According to one aspect, the low-pass filter works over an extent of 2 to 10 sampled values S(n). Such a computation is very fast and consumes limited memory resources.

According to one aspect, the incident radiofrequency signal corresponds to radar waves with frequencies ranging between 1 GhZ and 90 GHz. For example, the 6 GHz range can be used, or the 10 GHz range or the 24 GHz range or the 60 GHz range or even the 77 GHz range can be used.

According to one option, the incident electromagnetic waves are emitted in the form of a continuous transmission of electromagnetic signals, preferably with a predetermined carrier frequency and a constant amplitude. This principle is simple and inexpensive in terms of hardware and required resources.

According to another option, an FMCW (“Frequency-Modulated Continuous-Wave”) method can be used, in which the transmitted radiofrequency signal is frequency modulated. This allows additional information to be available concerning the distance of the moving object relative to the sensor.

According to one aspect, the predetermined threshold (ThA), with which the recurrent computation of standard deviation (σ(k)) is compared, ranges between 10 Hz and 20 Hz. A test campaign under real conditions can be conducted on a panel of users in order to determine which threshold value is the most relevant for discriminating between the voluntary or involuntary aspect of a gesture.

According to one aspect, the predetermined threshold (ThA) is a calibration parameter defined in relation to the targeted application for detecting gestures. It is thus possible to make the predetermined threshold specific to a particular application.

According to one aspect, the predetermined threshold is an adaptive value obtained by a self-learning process. For example, the number of re-tests of the user before successful opening, or depending on the common arrival-departure usage cycle of the vehicle.

According to one aspect, the first discrimination algorithm (Algo1) applied to the first component (Cp1) comprises determining and comparing the following features to reference values or curves: the amplitude, the frequency and/or the phase of the first component (Cp1).

According to one aspect, the amplitude of the first component is used to wake up the detection module, thus avoiding triggering the scan on low-amplitude noises.

According to one aspect, the frequency of the first component is used for recognizing a template (or ‘pattern’) representing expected gestures.

According to one aspect, the phase of the first component is used to distinguish a forward movement or a backward movement.

According to one aspect, provision is made for the method to further comprise the following step:
h/ deciding, as a function of the first and second discrimination results, the nature and the voluntary or involuntary character of a gesture performed by the user.

According to one aspect, provision is made for the method to further comprise a step of formulating and transmitting a setpoint for unlocking and/or opening an opening of a motor vehicle, when a predetermined and voluntary gesture is identified in step h/.

According to one aspect, the overall response time between the start of the gesture and the unlocking setpoint is less than 1 second, preferably less than 750 milliseconds. The use of the second discrimination algorithm does not significantly lengthen the overall response time perceived by the user.

A further aim of the present application is a system for detecting and discriminating gestures, characterized in that it is configured to implement a method according to the invention, with the system at least comprising a signal processing module. The signal processing module is configured to receive the basic signal, Sdp(t), as input and to provide said first discrimination result and said second discrimination result as output. The signal processing module preferably comprises at least one processor provided with at least one memory and at least one input and/or output port. The signal processing module advantageously comprises a microcontroller.

Advantageously, the system according to the invention further comprises a collector module provided with a radar transducer, with said collector module being configured for implementing steps a/ to c/ of the method according to the invention.

Further aspects, aims and advantages of the invention will become apparent upon reading the following description of an embodiment of the invention, which is provided by way of a non-limiting example.

The invention also will be better understood with reference to the accompanying drawings, in which:

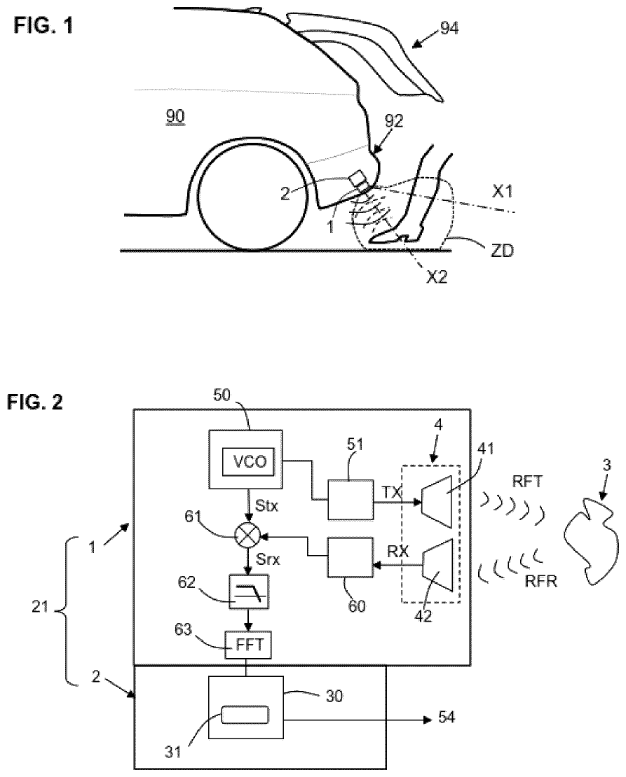

FIG. 1 illustrates a configuration in which a user U performs a gesture with the foot under the bumper of a vehicle in order to open the tailgate or the trunk of this vehicle;

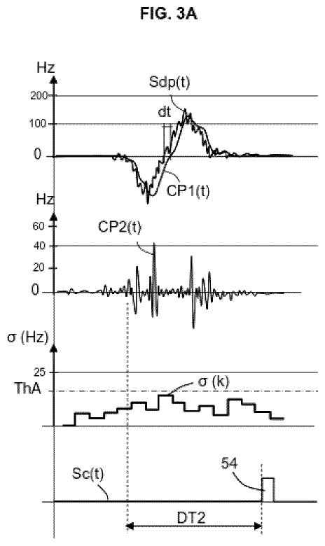

FIG. 2 shows a block diagram of the electronic circuits involved in the method according to the present invention;

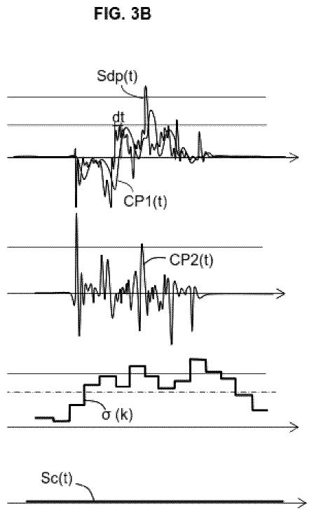

FIG. 3A and FIG. 3B show timing diagrams illustrating the processing and discrimination algorithms;

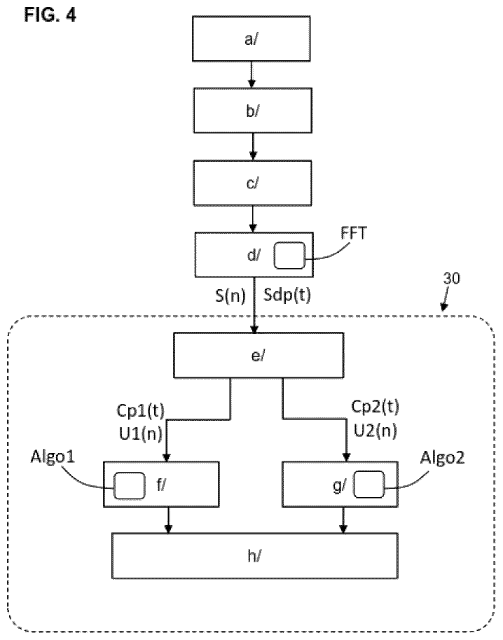

FIG. 4 schematically shows the steps of the method according to the present invention.

### DETAILED DESCRIPTION OF EMBODIMENTS

Throughout the various figures, the same reference signs have been used to designate identical or similar elements. For the sake of the clarity of the disclosure, some elements are not necessarily shown to scale.

FIG. 1 shows an example of a situation where the method according to the invention is implemented. A vehicle user performs a gesture with their foot under the rear bumper 92 in order to trigger an operation for opening the trunk or tailgate (reference 94, FIG. 1) of said vehicle 90. This function grants “hands-free” access to the internal area of the trunk, with opening of the trunk or tailgate being triggered by recognizing a predefined gesture performed by the foot of the user in front of a sensor. The gesture can involve a side sweep or a ‘kick’ (front-to-rear sweep).

In other configurations not shown in the figures, the method according to the invention can relate to a command for opening a sliding door, for example, by means of a gesture performed with the hand positioned in front of a sensor, with said sensor being able to be located close to the conventional opening handle of the sliding door.

Moreover, using the method according to the invention to command the opening of an element from inside the vehicle, for example, to command the opening of a sunroof, is not out of the question.

Furthermore, it is also possible to use the method according to the invention to command the closure of the tailgate or respectively the closure of the sliding door, with the gesture being able to be performed by a foot or a hand of a user.

It should be noted herein that, for a gesture performed from outside the vehicle, it is worthwhile considering that exogenous objects can be located near or inside the detection zone, such as, for example, plant elements, small animals, or various other objects whose trajectory can interfere with the detection zone considered herein.

With respect to the type of vehicle, this applies to any particular type of vehicle. Commercial vehicles of the light truck or van type are also applicable, for example, in terms of sliding doors.

The system according to the invention is a system for detecting and discriminating gestures, which attempts to identify a gesture substantially corresponding to an expected gesture and also attempts to discriminate the voluntary or involuntary character of said gesture.

In this case, the system comprises a collector module 1 (or simply a “sensor”) and a signal processing module 2. The collector module 1 and the signal processing module 2 can form an integrated unit 21 (FIG. 2), optimally arranged in order to be able to cover a desired detection zone ZD.

In other embodiments, separate modules can be involved. The collector module 1 is then arranged, for example, in the bumper, while the signal processing module is arranged at a distance, in another position in the vehicle or even housed in a multifunction computer.

In alternative embodiments (not shown), the collector module 1 does not form an integral part of the system according to the invention.

The system is intended to deliver unlocking or respectively locking command information.

However, such command information only must be delivered for the right reasons, i.e., after a predetermined voluntary gesture is performed by a legitimate user of the vehicle (driver or passenger(s)).

For this reason, the method and the system according to the invention must not only detect the occurrence of a gesture substantially resembling an expected gesture, but also must be able to discriminate such a desired gesture from a different movement that must not result in the provision of command information for the considered opening. Such a different movement can be an involuntary movement of a legitimate user of the vehicle (driver or passenger(s)) or other individuals, for example, passers-by.

Such a different movement also can be caused by plant elements (branches, leaves), small animals (i.e., dogs, cats) or various other objects whose trajectory can interfere with the detection zone ZD.

It is understood herein that the vehicle is considered to be stopped, i.e., at zero speed.

### Collector Module:

With reference to FIGS. 1 and 2, the collector module 1 comprises a radar transducer 4, with a transmission antenna 41 and a reception antenna 42 that can be contained in an integrated transducer. In alternative embodiments (not shown), a single antenna both transmits and receives a signal.

The collector module 1 comprises a circuit 50 for generating a source signal, with the signal being amplified by a driver 51, the output TX of which is delivered on the transmission antenna 41. In response, the transmission antenna 41 transmits an incident radiofrequency signal RFT.

The reception antenna 42 receives, among other things, echoes RFR, or a return radiofrequency signal, originating from the reflection of the incident radiofrequency signal on the objects 3 located in the detection zone ZD. In response to the reception of the return radio frequency signal RFR, the reception antenna 42 provides an electrical signal RX that is directed toward an amplifier 60, if applicable followed by a band-pass filter (not shown) in order to eliminate any echoes with a frequency that is too far from a frequency of interest.

The detection zone ZD corresponds to a volume of interest, located opposite the radar transducer 4, and which corresponds to the zone where the gesture is expected.

In a particular embodiment, provision can be made for a general monitoring detection zone, and a restricted detection zone for more precisely detecting and discriminating the expected gesture.

The purpose of the general monitoring zone is to be able to monitor the arrival or the movement of an object in said general monitoring zone (standby mode) with minimal power consumption. If such an event occurs, the system can transition to the restricted detection mode, with the limited detection zone, and greater authorized power consumption (wake-up mode).

In the example illustrated in FIG. 1, a general monitoring zone is a volume centered on the axis X1, while the restricted detection zone is a volume centered on the axis X2, with X1 being less inclined than X2 relative to the horizontal plane, when the vehicle is on such a horizontal plane, an adaptation of the radiation pattern of the antenna can be provided by means of a movable screen. Alternatively, two sensors can be provided instead of one, one for each detection zone.

With further reference to FIG. 2, the collector module 1 can further comprise means for low-level processing of the radiofrequency signals, namely, notably, the operation of mixing the filtered return radiofrequency signal, output from the amplifier 60 (respectively output from the aforementioned band-pass filter), with a copy of the incident radiofrequency signal.

More specifically, the signal Stx (portion of the source signal provided by the generation circuit 50) is mixed with the signal Srx (signal output from the amplifier 60, respectively output from the aforementioned band-pass filter) in an HF mixer 61. A beat between Stx and Srx occurs at this location. When a Doppler effect has been produced by an object moving in the detection zone ZD, the frequency of the signal Srx is affected by this Doppler effect and therefore differs from the frequency of the signal Stx. A low-pass filter 62, or anti-aliasing filter, is placed at the outlet of the mixer 61, with the effect of said filter being to suppress any frequency beats above a predetermined threshold, and to keep only the beat component that has the differential f(Srx)−f (Stx) between the frequency of Srx and the frequency of Stx as its frequency.

A frequency shifting step also can be provided for shifting the frequency differential f(Srx)−f(Stx) with respect to the zero frequency and thus easily obtaining the positive or negative sign information of said frequency differential (approaching or moving away). A relatively low intermediate frequency can be used for this frequency shift.

According to an alternative to the above solution, the approaching or moving away information is provided by analyzing the phase shift between the signals I and Q. These 2 signals I and Q are derived from 2 mixers fed by 2 quadrature oscillators.

The output of the low-pass filter 62, also called anti-aliasing filter, enters a fast Fourier transform (FFT) module 63. A temporal sequence of values S(n) is obtained at the output of this fast Fourier transform module 63.

More generally, the output of the fast Fourier transform module 63 represents a signal that is called the basic signal Sdp(t) hereafter, which represents an evolution of a Doppler shift as a function of time. The basic signal Sdp(t) is advantageously in the form of a temporal sequence of values S(n) (digital signal). S(n) is the digital representation of the basic signal Sdp(t).

It should be noted that the transition to digital could be carried out upon exiting the low-pass filter 62.

Downstream of the fast Fourier transform module 63, the temporal sequence of values S(n) is processed by the processing module 2 comprising a microcontroller 30, configured to implement the method according to the invention as described hereafter.

### Obtaining the Basic Signal:

The method implemented in the collector module 1 involves:
a/ transmitting an incident radiofrequency signal RFT toward the detection zone ZD;
b/ receiving a return radiofrequency signal RFR in return, originating from the reflection of the incident radiofrequency signal on elements located in the detection zone ZD;
c/ determining a frequency shift, called Doppler shift, between the incident radiofrequency signal RFT and the return radiofrequency signal RFR, the Doppler shift being a function of a movement of said elements located in the detection zone ZD, and the frequency shift being carried by the basic signal Sdp(t).

The incident radiofrequency signal is formed by radar waves with a frequency ranging between 1 GhZ and 90 GHz. For example, the 6 GHz range can be used, or the 10 GHz range or the 24 GHz range or the 60 GHz range or even the 77 GHz range can be used.

The incident radiofrequency signal RFT is transmitted in the form of a transmission of an electromagnetic signal defined by a determined frequency carrier and a constant amplitude envelope (called ‘CW’ mode). This principle is simple and inexpensive in terms of hardware and required resources. The selected fixed frequency can be one of those falling within the ranges specified above.

In another embodiment, an FMCW (“Frequency-Modulated Continuous-Wave”) method can be used, in which the transmitted radiofrequency signal is frequency modulated, this allows additional information to be available concerning the distance of the moving object relative to the collector module 1, at the cost of a slightly more complex collection module 1.

### Processing the Basic Signal:

In this case, the basic signal Sdp(t) will be processed in its digital form, namely the temporal sequence of values S(n) obtained at the output of the fast Fourier transform module 63.

The signal processing is implemented within the aforementioned processing module 2, in particular using a processor and a memory storing a suitable computer program product. The processing module 2 comprises a digital low-pass filter 31.

The temporal sequence of values S(n) comprises a number Pn of samples per second ranging between 500 and 2,000 (i.e., 500 Hz to 2 kHz for the sampling frequency).

Initially, the processing module 2 is used to split the basic signal Sdp(t) into a first component Cp1, obtained at the output of a low-pass filter 31, and a second component Cp2, obtained in addition (step e/ of the method).

More specifically, a low-pass filter is applied to the basic signal (S(n) values) in order to eliminate noise and high frequency components. The first component Cp1 is therefore a sequence of values denoted U1(n).

In order to obtain the second component Cp2, the first component Cp1 is generally subtracted from the basic signal Sdp(t).

However, it should be noted that the low-pass filter has introduced a delay. Consequently, according to a preferred arrangement, the first component Cp1 is advantageously time-shifted by the delay value introduced by the low-pass filter, before being subtracted from the basic signal in order to obtain the second component Cp2. The second component Cp2 is therefore a sequence of values denoted U2(n).

In other words, U2(n)=S(n)−U1(n−j), with j being the number of samples corresponding to the delay introduced by the low-pass filter, therefore corresponding to the necessary readjustment. In practice, the low-pass filter works over an extent j from 2 to 10 sampled values S(n).

Each component Cp1, Cp2 is then preferably processed at the same time.

A first discrimination algorithm Algo1 is applied to the first component Cp1 in order to obtain a first discrimination result, relating to the detection of a predetermined gesture (step f/ of the method).

The first algorithm Algo1 comprises determining and comparing at least one of the following features to reference values or curves: the amplitude, the frequency and/or the phase of the first component (Cp1). The amplitude of the first component is used to wake-up the collector module 1. This thus avoids triggering the signal processing on low-amplitude noises. The frequency of the first component is used for recognizing a template (or “pattern”) representing an expected gesture. The phase of the first component is used to distinguish a forward movement or a backward movement.

A second discrimination algorithm Algo2 is applied to the second component Cp2 in order to obtain a second discrimination result relating to the discrimination between a voluntary or involuntary gesture (step g/ of the method).

The second algorithm Algo2 comprises a recurrent computation of standard deviation σ(k) carried out based on a temporal sequence of values U2(n) of the second component Cp2 and over a sliding time window.

The recurrent computation of standard deviation σ(k) is carried out based on the values U2(n). The computation of standard deviation σ(k) is particularly carried out based on a set of M values of S(n), notably the most recently acquired values.

In practice, the computation of standard deviation σ(k) is carried out on a set of M values of U2(n), where M corresponds to the width of the sliding window. M can be selected between 50 to 250.

Therefore:

$$σ ( k ) = \sqrt{\frac{1}{M} {\sum }_{k}^{k - M + 1} {( U 2 ( k ) - \overline{U 2} )}^{2}} \qquad [ Math 1 ]$$

The index k corresponds to the most recent value of U2(n). Reconsidering M samples of U2. For example, the sliding window of M values assumes the values of the last 100 milliseconds or the values of the last 200 milliseconds.

The extent of the sliding window for the computation of standard deviation can be a calibration parameter M defined in relation to the application provided for detecting gestures.

The extent of the sliding window for the computation of standard deviation can be an adaptive value obtained by a self-learning process. For example, this extent is a function of the computation time of the processing module 2 for completing the computations of standard deviation.

The computation of standard deviation σ(k) is carried out a number Pk of times per second, where Pk ranges between 10 and 100, for example. According to one embodiment, Pk<Pn, where Pn is the number of samples of the basic signal per second. In other words, there is sub-sampling for the computation of the standard deviation with respect to the sampling of the basic signal. However, it is not out of the question that Pk=Pn.

The second discrimination result indicates a voluntary gesture when the recurrent computation of standard deviation σ(k) assumes values below a predetermined threshold ThA.

The predetermined threshold ThA, to which the recurrent computation of standard deviation σ(k) is compared, ranges between 10 Hz and 20 Hz, for example.

Depending on the standard deviation values in particular, the processing module 2 advantageously proceeds to a subsequent step involving deciding, as a function of the first and second discrimination results, upon the nature and the voluntary or involuntary character of a gesture performed by the user (step h/).

The processing module also, if applicable, proceeds to a step of formulating and transmitting an unlocking and/or opening setpoint 54 for an opening of a motor vehicle, when a predetermined and voluntary gesture is identified in step h/.

The predetermined threshold ThA advantageously is a calibration parameter, defined in relation to the application provided for detecting gestures. It is thus possible to make the predetermined threshold specific to a particular application.

The predetermined threshold can be an adaptive value obtained by a self-learning process.

In FIGS. 3A and 3B, the top graph illustrates the low-pass filtering of the signal Sdp(t) that yields the first component Cp1(t).

Below, and to a more precise scale, a second graph shows the second component Cp2(t) obtained by subtracting Cp1(t) from Sdp(t).

Further below, the curve illustrates the result of standard deviation a on a scale showing the predetermined threshold ThA.

A command signal Sc(t) is illustrated further below, assuming the zero value in the absence of the transmission of a command signal and a positive non-zero value in the presence of the transmission of an opening command.

It should be noted that the second component Cp2 is a second order component in terms of amplitude compared to the first component Cp1.

FIG. 3A illustrates a case of a voluntary gesture, with a command signal 54 then being transmitted, in order to command the opening of the trunk or the tailgate 94 of the motor vehicle 90. Conversely, FIG. 3B illustrates a case of an involuntary gesture.

It can be seen that σ(k) exceeds ThA on the straight part, whereas σ(k) remains below ThA on the left-hand part. On the chronogram in the right-hand part, no unlocking command action has occurred (command signal Sc(t) constant at the zero value).

In order to simplify the figures, the transmission of an opening command has been illustrated when σ(k) does not exceed ThA. According to the invention, the transmission of the opening command is also a function of the first discrimination result, obtained using the signal Cp1(t). In particular, when the first discrimination result indicates the presence of a predetermined gesture, the transmission of the opening command is further conditioned on the condition that σ(k) has not exceeded ThA at the corresponding detection instants (or that σ(k) has exceeded ThA at the corresponding detection instants, only for a negligible number of measurements).

On the top line, it can be seen that the delay dt related to the low-pass filtering has been exaggerated for the sake of the clarity of the disclosure.

The overall response time DT2 between the start of the gesture and the unlocking command is less than 1 second, preferably less than 750 milliseconds.

In other words, the method implemented in an integral unit 21 comprising the collector module 1 and the processing module 2 comprises the following steps:
a/ transmitting an incident radiofrequency signal RFT toward a detection zone ZD;
b/ receiving a return radiofrequency signal in return, originating from the reflection of the incident radiofrequency signal on elements located in the detection zone;
c/ determining a frequency shift, called Doppler shift, between the incident radiofrequency signal RFT and the return radiofrequency signal RFR, with the Doppler shift being a function of a movement of elements located in the detection zone;
d/ forming a basic signal, Sdp (t), representing an evolution of the determined Doppler shift in step c/ as a function of time;
e/ splitting the basic signal into a first component (Cp1) obtained at the output of a low-pass filter, and a second component (Cp2) obtained by subtracting the first component from the basic signal;
f/ applying a first discrimination algorithm (Algo1) to the first component (Cp1) in order to obtain a first discrimination result, relating to the detection of a predetermined gesture;
g/ applying a second discrimination algorithm (Algo2) to the second component (Cp2) in order to obtain a second discrimination result relating to the discrimination between a voluntary or involuntary gesture;
   the second discrimination algorithm (Algo2) comprising a recurrent computation of standard deviation (σ(k)) carried out based on a temporal sequence of values (U2(n)) of the second component (Cp2) and over a sliding time window;
   the second discrimination result indicating a voluntary gesture when the recurrent computation of standard deviation (σ(k)) assumes values below a predetermined threshold ThA.

1. A method for detecting and discriminating gestures, intended to be implemented within a motor vehicle for controlling an opening and/or for unlocking an opening when a predetermined voluntary gesture is detected, said gesture being performed by a user (U), notably by a hand, a foot, an arm or a leg of the user, the method being implemented by at least one signal processing module, and comprising the following steps:
d/ obtaining a basic signal, Sdp(t), representing, as a function of time, an evolution of a determined Doppler shift following the transmission of an incident radiofrequency signal (Tx) and the reception of a return radiofrequency signal forming an echo;
e/ splitting the basic signal into a first component (Cp1) obtained at the output of a low-pass filter, and a second component (Cp2) obtained by subtracting the first component from the basic signal;
f/ applying a first discrimination algorithm (Algo1) to the first component (Cp1) in order to obtain a first discrimination result, relating to the detection of a predetermined gesture;
g/ applying a second discrimination algorithm (Algo2) to the second component (Cp2) in order to obtain a second discrimination result relating to the discrimination between a voluntary or involuntary gesture;
the second discrimination algorithm (Algo2) comprising a recurrent computation of standard deviation (σ(k)) carried out based on a temporal sequence of values (U2(n)) of the second component (Cp2) and over a sliding time window;
the second discrimination result indicating a voluntary gesture when the recurrent computation of standard deviation (σ(k)) assumes values below a predetermined threshold (ThA).

2. The method as claimed in claim 1, comprising the following preliminary steps:
a/ transmitting an incident radiofrequency signal (RFT) toward a detection zone (ZD);
b/ receiving a return radiofrequency signal in return, originating from the reflection of the incident radiofrequency signal on elements located in the detection zone;
c/ determining a frequency shift, called Doppler shift, between the incident radiofrequency signal and the return radiofrequency signal, the Doppler shift being a function of a movement of said elements located in the detection zone, and constructing the basic signal Sdp(t).

3. The method as claimed in claim 1, wherein the basic signal Sdp(t) is in digital form, i.e., in the form of a temporal sequence of values (S(n)), preferably with a number of samples per second (Pn) ranging between 500 and 2,000.

4. The method as claimed in claim 3, wherein the temporal sequence of values (S(n)) is obtained at the output of a fast Fourier transform (FFT) module.

5. The method as claimed in claim 1, wherein the recurrent computation of standard deviation (σ(k)) carried out based on a temporal sequence of values (U2(n)) is carried out a number Pk of times per second, with Pk ranging between 10 and 100.

6. The method as claimed in claim 5, wherein the extent of the sliding window for the recurrent computation of standard deviation (σ(k)) ranges between 0.1 second and 0.2 seconds.

7. The method as claimed in claim 1, wherein the first component is time-shifted by a delay value introduced by the low-pass filter, before being subtracted from the basic signal in order to obtain the second component (Cp2).

8. The method as claimed in claim 1, wherein the low-pass filter works over an extent of 2 to 10 sampled values S(n).

9. The method as claimed in claim 1, wherein the predetermined threshold (ThA), with which the recurrent computation of standard deviation (σ(k)) is compared, ranges between 10 Hz and 20 Hz.

10. The method as claimed in claim 1, wherein the predetermined threshold (ThA) is a calibration parameter defined in relation to the application for detecting gestures.

11. The method as claimed in claim 1, wherein the predetermined threshold (ThA) is an adaptive value obtained by a self-learning process.

12. The method as claimed in claim 1, wherein the first discrimination algorithm (Algo1) applied to the first component (Cp1) comprises determining and comparing the following features to reference values or curves: the amplitude, the frequency and/or the phase of the first component (Cp1).

13. The method as claimed in claim 1, further comprising the following step:
h/ deciding, as a function of the first and second discrimination results, the nature and the voluntary or involuntary character of a gesture performed by the user.

14. The method as claimed in claim 13, characterized in that it further comprises a step of formulating and transmitting a setpoint for unlocking and/or opening an opening of a motor vehicle, when a predetermined and voluntary gesture is identified in step h/.

15. A system for detecting and discriminating gestures, characterized in that it is configured to implement the method as claimed in claim 1, the system at least comprising a signal processing module (2), said signal processing module being configured to receive the basic signal, Sdp(t), as input and to provide said first discrimination result and said second discrimination result as output.
